(19) United States
(12) Patent Application Publication
(10) Pub. No.: US 2020/0019850 A1
(43) Pub. Date: Jan. 16, 2020

(54) CIRCUIT NEUROMORPHIQUE IMPULSIONNEL IMPLEMENTANT UN NEURONE FORMEL

(71) Applicant: COMMISSARIAT À L'ÉNERGIE ATOMIQUE ET AUX ÉNERGIES ALTERNATIVES, Paris (FR)

(72) Inventors: Alexandre Valentian, Grenoble Cedex 09 (FR); Olivier Bichler, Grenoble Cedex 09 (FR); François Rummens, Grenoble Cedex 09 (FR)

(21) Appl. No.: 16/508,565

(22) Filed: Jul. 11, 2019

(30) Foreign Application Priority Data
Jul. 12, 2018 (FR) 1856439

(51) Int. Cl. G06N 3/063; G06N 3/04

(52) U.S. Cl. CPC G06N 3/0635; G06N 3/049

(57) ABSTRACT

An impulse-neuron-type neuromorphic circuit comprises a capacitor (Cₘₑₘ) having a membrane voltage (Vₘₑₘ), a first action comparator (1) for comparing the membrane voltage with a first action voltage (V_{act}, V_{threshold_high}), a first regulation comparator (4) for comparing the membrane voltage with a first regulation voltage (V_{reg}), a device for reinitialising the membrane voltage (3) a register of threshold exceeds (5) and a regulator (2). The regulator is configured: in case of exceeding the first regulation voltage (V_{reg} V_{threshold_low}) by the membrane voltage, to control the device for reinitialising the membrane voltage (3) and modify the register of threshold exceeds (5); and in case of exceeding the first action voltage (V_{act} V_{threshold_high}) by the membrane voltage, to control the device for reinitialising the membrane voltage (3) and query the register of threshold exceeds to decide whether or not to generate an action potential (Sₚₐ) on an output of the neuromorphic circuit.

### TECHNICAL FIELD

The field of the invention is that of artificial neuron networks. The invention relates more particularly to a neuromorphic circuit of the spiking neuron type configured in such a way as to operate in a manner equivalent to a formal neuron.

### PRIOR ART

A nerve cell, or neuron, can be broken down into several parts:
Dendrites which are the inputs of the neuron via which it receives excitation or inhibition signals;
The body of the neuron which is the theatre of ionic exchanges through the cell membrane;
The axon, a long extension of the cell body, which is the only output of the neuron.

According to the excitation or inhibition signals received on the dendrites, ions transit through the cell membrane. The imbalance in charges between the inside and the outside of the cell induces a voltage different on either side of the membrane. This is then referred to as membrane voltage at the terminals of a membrane capacitor. When this membrane voltage exceeds a certain level, i.e. when the cell is sufficiently excited, the neuron experiences a brutal exchange of ions. This results in a significant variation in the membrane voltage. This variation, called action potential (or spike), propagates along the axon, to the synaptic buttons, the outputs of the neuron. Seen from outside the cell, these “spikes” constitute the electrical activity of the neuron.

In a network of biological neurons, each neuron is connected to several thousand others via as many synapses. The term synapse designates the connection between the axon termination of a so-called pre-synaptic neuron and a dendrite of a so-called post-synaptic neuron. The influence of the pre-synaptic neuron on the post-synaptic neuron is weighted by the weight of the synapse which can be excitatory or inhibitory. In the first case, a pre-synaptic “spike” charges the membrane voltage of the post-synaptic neuron and precipitates the generation of a post-synaptic action potential. In the second case, a pre-synaptic “spike” has for effect to depolarise the post-synaptic membrane and to delay the appearance of a post-synaptic action potential.

Artificial neuron networks are used in various fields of signal processing (visual, audio or other) such as for example in the field of image classification or recognition. They are inspired by biological neuron networks of which they imitate the operation and are substantially comprised of artificial neurons that are interconnected together by synapses, which are conventionally implemented by digital memories, but which can also be implemented by resistive components of which the conductance varies according to the voltage applied to their terminals.

A first artificial neuron model is the one of the formal neuron. According to this model shown in FIG. 1, an emission frequency of “spikes” is associated with each neuron. This frequency is encoded as a simple digit and forms the output of the neuron.

Each neuron therefore takes as input and through the synapses the frequencies freq_{IN1}, freq_{IN2}, freq_{IN3}, freq_{INn} of the pre-synaptic neurons that are connected to it. The calculation then consists in multiplying each one of these frequencies by the corresponding synaptic weight w₁ⱼ, w₂ⱼ, w₃ⱼ, wₙⱼ then in accumulating all of these weight x frequency products. The sum of these products is then injected into a non-linear block, called an activation function, which supplies the frequency of the neuron freq_{OUT}.

Two main types of activation functions are used for formal neurons:
The ReLU (for “Rectified Linear Unit) which delivers as shown in FIG. 2 a frequency freq_{OUT} that is zero if the sum Σ of the weight x frequency products is negative and which is proportional to the sum Σ when the latter is greater than zero. This activation function does not impose any upper limit on the frequency;
The hyperbolic tangent or sigmoid shown in FIG. 3a, that is also found in linear form by part as shown in FIG. 3b. This activation function can result in a negative frequency. The output frequency of the neuron is limited according to −freq_{MAX}≤freq_{OUT}≤freq_{MAX}.

In addition to their simplicity, formal neurons have a major interest in terms of supervised learning thanks to the retro-propagation method of the gradient. However, their hardware implementation on a calculator has the disadvantage of excessive consumption and, to a lesser degree, is too bulky. The implementation thereof in an embedded system (multifunction mobile, autonomous vehicles or connected object for example) or as an accelerator within a processor is thus compromised.

Another artificial neuron model is that of the impulse neuron (also called action potential neuron or spiking neuron). The impulse neuron is closer to the biological neuron than the formal neuron in that it generates action potentials (also called impulses or spikes) and very often models a membrane voltage as well as a threshold. The simplest model of the impulse neuron is of the threshold integrating type (“Integrate and Fire”): it integrates its inputs, compares the result of this integration with a threshold and emits an action potential when this threshold is crossed.

With a concern for saving consumption and surface, the idea of a network of analogue impulse neurons connected by synapses taking the form of non-volatile resistive elements of the RRAM type (“Resistive Random-Access Memory”) attracts many designers. The principle of such an implementation is shown in FIG. 4. The contribution V_{spike_pre} of a pre-synaptic neuron is weighted by the value of the corresponding synaptic resistance R_{synb} and thus supplies an excitation current I_{symb}. This current is injected into a capacitor Cₘ which thus integrates the different stimulations over time. The membrane voltage, modelled by the voltage Vₘₑₘ at the terminals of the capacitor Cₘ, is compared to a threshold Vₜₕᵣₑₛₕ. When the latter is exceeded by the membrane voltage, a spike Vₛₚᵢₖₑ is emitted and the capacitor is discharged in order to reinitialise the membrane voltage, typically by resetting it.

There are thus, on the one hand, formal neurons suitable for carrying out the learning of a network of neurons and, on the other hand, compact impulse neurons that have low energy consumption. A strategy stems from this situation which consists, such as for example described in the article by B. Rueckauer et al., “Conversion of Continuous-Valued Deep Networks to Efficient Event-Driven Networks for Image Classification”, Front Neurosci. 2017 Dec. 7; 11:682, in carrying out the learning required for the proper operation of the network by using formal neurons, then in implementing the network thus learned thanks to impulse neurons. But in order to properly carry out such a strategy, an impulse implementation must be available that is able to implement the formal model.

Constraints that bear down on the design of an analogue impulse neuron so that it can operate in a way equivalent to a formal neuron by producing a train of impulses (spike train) representative of the output frequency of the formal neuron are as follows.

In the case of an activation function of the sigmoid type, in order to imitate the limitation in frequency, a so-called refractory period has to be introduced that corresponds to the minimum time that separates the generation of two successive action potentials by the impulse neuron. The duration of this refractory period corresponds to the inverse of the maximum frequency imposed by the formal model.

Other elements required for the equivalence concern constant frequency plateaus that can be seen in FIGS. 2 and 3b (which correspond to the refractory period in the case of a sigmoid activation function and to the zero frequency plateau for the ReLU activation function). In the case of the sigmoid, the equivalence requires pursuing the integration of the input stimulations that arrive during the refractory period in order to, where applicable, emit a new action potential at the expiry of the refractory period. For the ReLU, the negative integration has to be able to reach a substantial absolute value. In both cases, it is necessary to continue to integrate the input stimulations without being able to emit an action potential, and therefore without being able to reduce the membrane voltage via a discharge of the membrane capacitor.

Such a pursuit of the integration cannot however be carried out satisfactorily in analogue.

In the case of a sigmoid, the duration of the refractory period can be such that the stimulations arriving at the input of the neuron during this period correspond to several action potentials. Taking the example of a network wherein the synapses can have integer weights ranging from −4 to +4 and the analogue neuron is designed so that an excitation of weight with an absolute value 4 generates an action potential, the membrane voltage is able to reach the levels +20, +30 or even more during the refractory period. As the voltage range of the recent technologies is about a Volt, quanta of membrane voltage of about a few tens of mV must therefore be provided. And the lower this quantum is, the more sensitive the neuron is to errors concerning mistuning, non-linearity and noise. Providing in analogue the pursuit of the integration during the refractory period therefore substantially degrades the general operation of the neuron.

For a ReLU activation function, the analogue solution can be considered even less, as the excursion of the sum Σ in the negative can be very substantial.

Thus, in practice, the pursuit of the integration in the cases where there cannot be any generation of action potential risks leading to an analogue saturation of the membrane voltage.

### DISCLOSURE OF THE INVENTION

The invention has for objective to allow for the implementation of the aforementioned strategy by means of a neuromorphic circuit of the impulse neuron type that operates in a manner equivalent to a formal neuron. The invention aims more particularly to respond to the problem of the analogue saturation of the membrane voltage.

To do this, the invention proposes a neuromorphic circuit of the spiking neuron type which comprises a capacitor at the terminals of which is established a membrane voltage, an action comparator configured to compare the membrane voltage to a first action voltage, a first regulation comparator for comparing the membrane voltage with a first regulation voltage, a device for reinitialising the membrane voltage, a register of threshold exceeds. This regulator is configured:
in case of exceeding the first regulation voltage by the membrane voltage, in particular when the circuit must not generate an action potential, to control the device for reinitialising the membrane voltage and to modify the register of threshold exceeds;
in case of exceeding of the first action voltage by the membrane voltage, in particular when the circuit must not generate an action potential, to control the device for reinitialising the membrane voltage and to query the register of threshold exceeds to decide whether or not to generate an action potential on an output of the neuromorphic circuit.

Certain preferred but non-limiting aspects of this neuromorphic circuit are the following:
the regulator is configured to, in case of exceeding the first action voltage by the membrane voltage, control the device for reinitialising the membrane voltage so as to modify the charge of the membrane capacitor by a predetermined charge quantity;
the regulator is configured to, in case of exceeding the first regulation voltage by the membrane voltage, control the device for reinitialising the membrane voltage so as to modify the charge of the membrane capacitor by a predetermined charge quantity;
the register of threshold exceeds is a counter that is decremented in case of exceeding the first regulation voltage by the membrane voltage and which, when it indicates a negative value, is incremented in case of exceeding the first action voltage by the membrane voltage;
in case of exceeding the first action voltage by the membrane voltage, the regulator decides to generate an action potential when the counter indicates a zero value, with the latter then not being modified;
it comprises a second regulation comparator configured to compare the membrane voltage to a second regulation voltage and a second action comparator configured to compare the membrane voltage to a second action voltage, and the regulator is further configured:
   in case of exceeding the second regulation voltage by the membrane voltage, in particular when the circuit must not generate an action potential, to control the device for reinitialising the membrane voltage and modify the register of threshold exceeds,
   in case of exceeding the second action voltage by the membrane voltage, in particular when the circuit must not generate an action potential, to control the device for reinitialising the membrane voltage and query the register of exceed registers to decide whether or not to generate an action potential on an output of the neuromorphic circuit;
the regulator is configured to control the device for reinitialising the membrane voltage and modify the register of threshold exceeds in case of exceeding the first or the second regulation voltage by the membrane voltage only during a time window following the emission of an action potential on an output of the neuromorphic circuit, the action potential being of a first or of a second type;
the regulator is furthermore configured to decide whether or not to generate an action potential of the first type or of the second type on an output of the neuromorphic circuit at the expiry of said time window;
the register of threshold exceeds is a counter and the regulator is configured, during said time window, to increment the counter in case of exceeding the second regulation voltage by the membrane voltage and to decrement the counter in case of exceeding the first regulation voltage by the membrane voltage;
the regulator is furthermore configured, at the expiry of said time window, to generate an action potential of the first type and to decrement the counter if the counter indicates a positive value and to generate an action potential of the second type and to increment the counter if the counter indicates a negative value;
the regulator is furthermore configured to generate an action potential of the first type, respectively of the second type, on the output of the neuromorphic circuit in case of exceeding, outside the time window, the first action voltage, respectively the second action voltage, by the membrane voltage;
it exploits a same high threshold comparator to constitute the first action comparator and the second regulation comparator and a same low threshold comparator to constitute the second action comparator and the first regulation comparator.

The invention extends to a network of artificial neurons, comprising a plurality of neuromorphic circuits according to the invention as well as to a method for controlling a neuromorphic circuit according to the invention.

### BRIEF DESCRIPTION OF THE DRAWINGS

Other aspects, purposes, advantages and characteristics of the invention shall appear better when reading the following detailed description of preferred embodiments of the latter, given by a non-limiting example, and given in reference to the accompanying drawings wherein, in addition to FIGS. 1 to 4 already discussed hereinabove

FIG. 5 is a diagram of a possible embodiment of an impulse neuromorphic circuit according to the invention

FIG. 6 shows a possible implementation of an impulse neuron that reproduces the behaviour of a sigmoid activation function and FIG. 7 shows a state machine followed by the regulator of the neuron of FIG. 6;

FIG. 8 shows a possible implementation of an impulse neuron that reproduces the behaviour of a ReLU activation function and FIG. 9 shows a state machine followed by the regulator of the neuron of FIG. 8.

### DETAILED DISCLOSURE OF PARTICULAR EMBODIMENTS

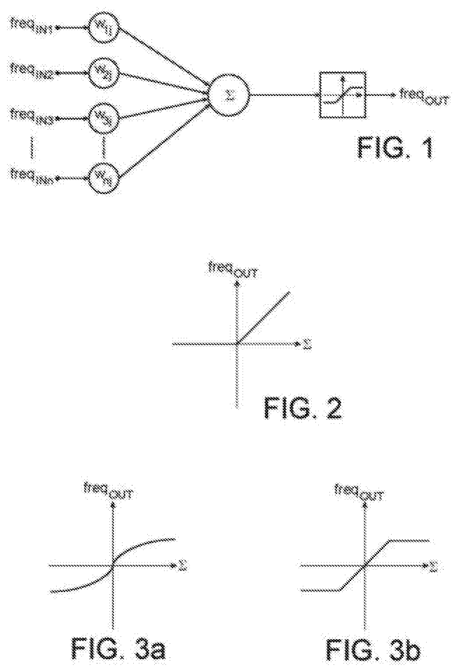

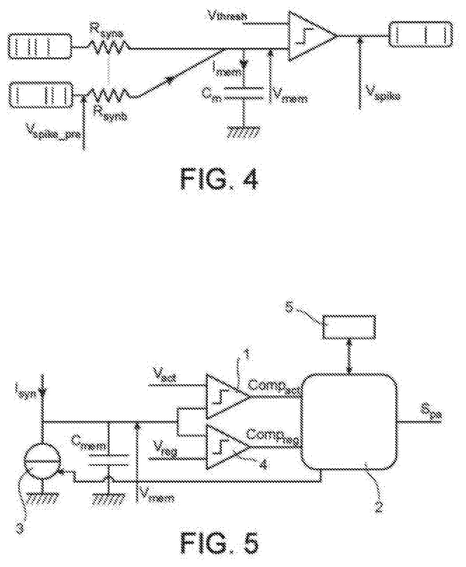

The invention relates to a neuromorphic circuit of the impulse neuron type, configured in such a way as to be able to operate in a manner equivalent to a formal neuron. In reference to FIG. 5, this circuit comprises an input for receiving a synaptic current I_{syn} corresponding to the total of the contributions of each pre-synaptic neuron, each one of these contributions being weighted by the value of the corresponding synaptic resistance. This current I_{syn} is injected into a membrane capacitor Cₘ at the terminals of which is established the membrane voltage Vₘ. The membrane voltage Vₘ is compared to at least one action voltage V_{act} by means of an action comparator 1 which provides as a comparison result a signal comp_{act}. A regulator 2 makes use of the signal comp_{act} to, in case of an exceeding the least one action voltage by the membrane voltage, generate an action potential Sₚₐ and control a device for reinitialising the membrane voltage, for example a current injector 3 connected to the reception input of the synaptic current, so as to modify the charge of the membrane capacitor. This modification of the charge can correspond to a full charge or a discharge (this is then referred to as an absolute reset of the membrane voltage) or to a partial charge or discharge (this is then referred to as a relative reset of the membrane voltage) of the membrane capacitor by which a predetermined charge quantity is added or subtracted to the charge of the membrane capacitor. Taking the example of a positive action voltage, a partial charge or discharge can be carried out in such a way as to subtract a charge quantity such that the action voltage is subtracted from the membrane voltage.

The action thresholding carried out by the circuit according to the invention is adapted to the chosen activation function. For an activation function of the ReLU type that does not include any negative frequency, a single action comparator is required. In the case of an activation function of the sigmoid type, two action comparators are required, once associated with a high threshold and the other associated with a low threshold (typically the negative of the high threshold), and the regulator is configured in such a way as to be able to generate signed action potentials, namely a positive action potential in case of exceeding the high threshold and a negative action potential in case of exceeding the low threshold.

The neuromorphic circuit according to the invention further comprises at least one regulation comparator 4 for comparing the membrane voltage Vₘₑₘ to a regulation voltage V_{reg} and provide as a comparison result a signal comp_{reg}, as well as a register of threshold exceeds 5. The regulator 2 is configured to, in case of exceeding of the regulation voltage V_{reg} by the membrane voltage Vₘₑₘ when the circuit must not generate any action potential (either its membrane voltage is negative for a ReLU, or a refractory period is in effect for a sigmoid), control the device for reinitialising the membrane voltage 3 so as to modify, entirely or partially, the charge of the membrane capacitor and modify the register of threshold exceeds 5.

In the case of an activation function of the ReLU type, the neuromorphic circuit comprises an action comparator 1 associated with a high threshold (the action voltage) and a regulation comparator 4 associated with a low threshold (the regulation voltage). The low threshold is not used to generate action potentials but to detect when the membrane voltage Vₘₑₘ is too low. When this low threshold is exceeded, the voltage Vₘₑₘ is increased by means of an increase in the charge of the membrane capacitor (which makes it possible to limit the negative excursion of the membrane voltage) and the register of threshold exceeds 5 is modified to retain a trace of this increase. In other terms, continuing to integrate negative stimulations that could saturate the membrane voltage is prevented, and information relative to the increase or increases carried out on the membrane voltage is stored in the register.

The regulator 2 is furthermore configured to, in case of exceeding of the action voltage V_{act} by the membrane voltage Vₐₘ, control the device for reinitialising the membrane voltage so as to discharge the membrane capacitor and query the register of threshold exceeds to decide whether or not to generate an action potential Sₚₐ. In particular, an action potential is not generated if the register retains a trace of one or several increases of the membrane voltage. The discharging of the membrane capacitor is a total or partial discharge, with the latter being carried by subtracting a predetermined charge quantity to the charge of the membrane capacitor, for example a charge quantity such that the action voltage is subtracted from the membrane voltage.

The register of threshold exceeds can be a counter which is decremented in case of exceeding of the regulation voltage by the membrane voltage (i.e. when the low threshold is exceeded). In case of exceeding of the action voltage by the membrane voltage, the regulator decides to generate an action potential Sₚₐ when the counter indicates a zero value, with the latter then not being modified, and to not generate an action potential when the counter indicates a negative value, with this value then be incremented.

Now take the example of an activation function of the sigmoid type, the neuromorphic circuit requires two regulation comparators, one associated with a high threshold in order to compare the membrane voltage to a first regulation voltage, the other associated with a low threshold in order to compare the membrane voltage to a second regulation voltage. These regulation comparators will make it possible to avoid a possible saturation of the membrane voltage during the refractory periods. Thus, during a time window following the generation of an action potential on an output of the neuromorphic circuit (refractory period), in case of exceeding of the first or of the second regulation voltage by the membrane voltage Vₘₑₘ, the regulator controls the device for reinitialising the membrane voltage 3 so as to reduce or increase the charge of the membrane capacitor and modify the register of threshold exceeds 5. In other terms, continuing to integrate positives or negative stimulations that could saturate the membrane voltage during a refractory period is prevented, and information relative to the realisation or realisations of an adaptation of the membrane voltage is stored in the register.

The register of threshold exceeds can be a counter which is incremented in case of exceeding the second regulation voltage by the membrane voltage during a refractory period and which is decremented in case of exceeding of the first regulation voltage by the membrane voltage during a refractory period.

We have seen hereinabove that with a sigmoid activation function, the neuromorphic circuit must be able to generate signed action potentials, and can for this require two action comparators, a first associated with a high threshold (first action voltage) and a second one associated to a low threshold (second action voltage). In an advantageous embodiment, the circuit actually comprises only two comparators, with each one in charge of a double action function (for the generating of an action potential outside the refractory period) and regulation (for the detecting of a possible saturation of the membrane voltage in refractory period). In this embodiment, the first action comparator and the second regulation comparator form a same high threshold comparator 1 and the second action comparator and the first regulation comparator for a same low threshold comparator 4.

The regulator is furthermore configured to:
if the counter indicates a positive value at the expiry of a refractory period, generate an action potential of a first type (positive action potential for example) and decrement the counter;
if the counter indicates a negative value at the expiry of a refractory period, generate an action potential of a second type (negative action potential for example) and increment the counter.

And, outside of the refractory periods, the regulator is configured to generate an action potential of the first type in case of exceeding of the first regulation voltage by the membrane voltage and an action potential of the second type on the output of the neuromorphic circuit in case of exceeding of the second regulation voltage by the membrane voltage.

The regulator is thus configured to be able to operate according to two modes: refractory period and normal operation. During a refractory period, the counter is incremented or decremented according to the crossing of the regulation thresholds, the reinitialising of the membrane voltage is effective although no action potential is generated. In normal operation, the counter is unstacked if needed (a positive or negative potential is generated if the counter is positive or negative), the action potentials are generated in the usual way and are accompanied by a modification in the charge of the membrane capacitor in order to fully or partially reinitialise the membrane voltage. A refractory period starts after the generation of each action potential and is completed at the expiry of a timer.

Note that the implementation of a neuron corresponding to a ReLU activation function or to a sigmoid activation function makes use of the same equipment base: two comparators, a regulator, a device for reinitialising the membrane voltage and a register of threshold exceeds. It is thus possible to develop a “two-in-one” neuron that can, as selected, reproduce the behaviour of a ReLU or sigmoid activation function.

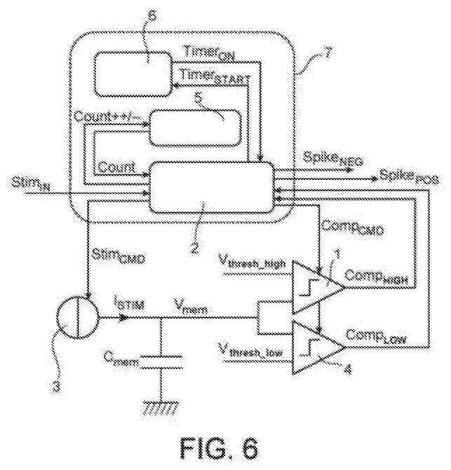

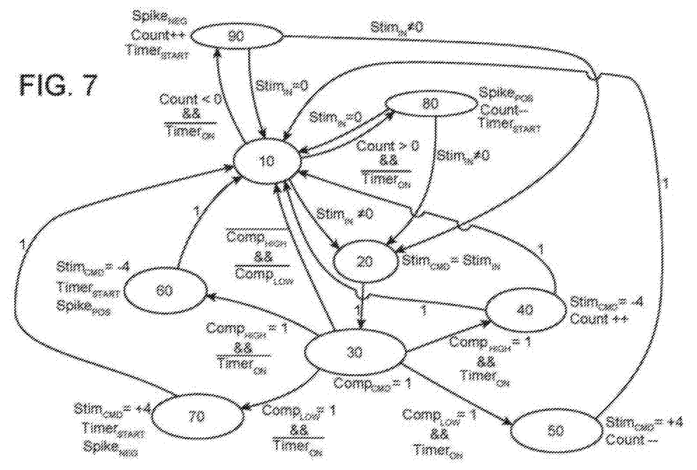

A possible implementation of an impulse neuron that reproduces the behaviour of a sigmoid activation function is shown in FIG. 6. In this figure, the elements that are common with FIG. 5 bear the same references except for the thresholds which are here noted as V_{thresh_high} and V_{thresh_low} and the outputs of the comparators which are here noted as Comp_{high} and Comp_{low}. A current referenced as I_{STIM} is injected into the membrane capacitor Cₘₑₘ. This current is supplied by a device for reinitialising the membrane voltage which here takes the form of a current injector 3 controlled by means of a digital command signal stim_{CMD} emitted by the regulator 2. The regulator 2, the counter 5 and a timer 6 form a digital block 7 of the neuromorphic circuit.

The following characteristics can be taken as an example:
Number of levels of the membrane voltage: 14 (from −7 to +7),
High threshold=+4 and low threshold=−4,
Partial charge/discharge of the membrane capacitor in order to perform a relative reset consisting in adding to/subtracting from the membrane voltage a predetermined charge quantity such that voltage equivalent to the exceeded threshold is added/subtracted from the membrane voltage;
Difference between two voltage levels: 64 mV,
Current to be injected to pass the membrane voltage from one voltage level to another (+1): 160 nA,
Size of the counter: 3 bits+1 sign bit.

The regulator 2 takes as input an excitation command Stim_{IN} representative of the activity of the pre-synaptic neurons, the outputs of the comparators Comp_{high} and Comp_{low}, information on the activity of the timer Timer_{ON} (refractory period in progress) and a Count information on the value of the counter. It has for outputs the command signal stim_{CMD} of the current injector 3, an incrementation command Count++ or decrementation Count− of the counter, a command Timer_{START} for starting the timer, a comparison command Comp_{CMD}, a positive action potential Spike_{POS} and a negative action potential Spike_{NEG}.

The regulator is configured to implement the state machine shown in FIG. 7. Starting from a holding state 10, in the presence of a stimulation as input (Stim_{IN}≠0), it switches to a state 20 where it copies the input Stim_{IN} on its output Stim_{CMD} then in a state 30 of comparison with the thresholds where it emits the comparison command Comp_{CMD}.

When the timer is in activity (Timer_{ON} indicating a refractory period) and the high threshold is exceeded (Comp_{high}=1), it switches to a state 40 of discharging the membrane capacitor (via the command Stim_{CMD}=−4) and of storing of a positive action potential (via the incrementation Count++ of the counter 5).

When the timer is in activity (Timer_{ON} indicating a refractory period) and the low threshold is exceeded (Comp_{low}=1), it switches to a state 50 of charging the membrane capacitor (via the command Stim_{CMD}=+4) and of storing a negative action potential (via the decrementation Count− of the counter 5).

When the timer is not in activity (T̅i̅m̅e̅r̅O̅N̅, outside of a refractory period) and the high threshold is exceeded (Comp_{high}=1), it switches to a state 60 of generating a positive action potential Spike_{POS}, of discharging the membrane capacitor (via the command Stim_{CMD}=−4) and of starting the timer (via the command Timer_{START}).

When the timer is not in activity (T̅i̅m̅e̅r̅O̅N̅, outside of a refractory period) and the low threshold is exceeded (Comp_{low}=1), it switches to a state 70 of generating a negative action potential Spike_{NEG}, of charging the membrane capacitor (via the command Stim_{CMD}=+4) and of starting the timer (via the command Timer_{START}).

The regulator switches from each one of the states 40, 50, 60 and 70 to the holding state 10. This holding state 10 is exited at the expiry of a refractory period (T̅i̅m̅e̅r̅O̅N̅) in order to reach a state 80 or 90 according to whether the counter displays a positive or negative value. If the counter displays a positive value, a positive action potential Spike_{POS} is generated, the counter is decremented and the timer is started via the command Timer_{START}. On the other hand, if the counter displays a negative value, a negative action potential Spike_{NEG} is generated, the counter is incremented and the timer is started via the command Timer_{START}. Then, in the absence of an input stimulation (Stim_{IN}=0), it switches back to the holding state 10 when it switches back to the state 20 of copying the input Stim_{IN} on its output Stim_{CMD} in the presence of input stimulation (Stim_{IN}≠0).

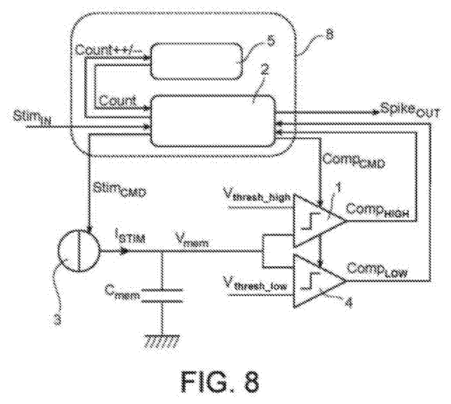

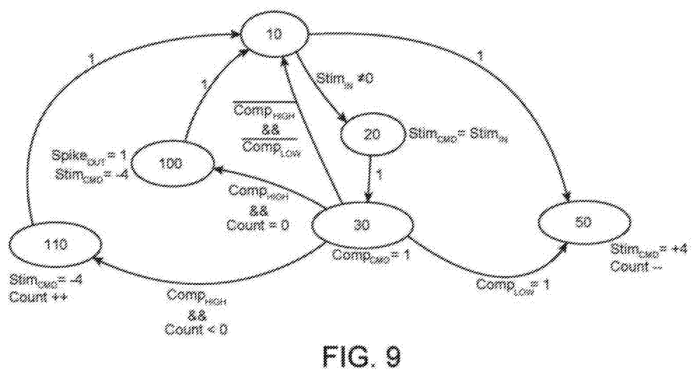

FIG. 8 shows a possible implementation of an impulse neuron that reproduces the behaviour of a ReLU activation function. This implementation is similar to that of the neuron of FIGS. 6 and 7, but its digital block 8 is simplified: there is no timer and the regulator 2 is configured to implement the state machine shown in FIG. 9 generating only one type of action potential Spike_{OUT}.

In this FIG. 9, the states 10, 20, 30 and 50 are identical to those bearing the same references in FIG. 7. Starting from the state 30 of comparison with the thresholds, if the low threshold is exceeded (Comp_{low}=1), the machine switches to the state 50 of charging the membrane capacitor (via the command Stim_{CMD}=+4) and of storing information relative to the occurrence of such a charging (via the decrementation Count− of the counter 5).

Starting from the state 30 of comparison with the thresholds, if the high threshold is exceeded (Comp_{high}=1) and the counter displays a zero value, the machine switches to a state 100 of generating an action potential Spike_{OUT} and of discharging the membrane capacitor (via the command Stim_{CMD}=−4).

Starting from the state 30 of comparison with the thresholds, if the high threshold is exceeded (Comp_{high}=1) and the counter displays a negative value, the machine switches to a state 110 of discharging the membrane capacitor (via the command Stim_{CMD}=−4) and of incrementing Count++ of the counter.

The invention is not limited to the neuromorphic circuit described hereinabove but also extends to a network of artificial neurons comprising a plurality of such neuromorphic circuits, for example connected together via resistive synapses of the RRAM type.

The invention also relates to a method for controlling an impulse neuron in order to render it equivalent to a formal neuron, with this method comprising when the impulse neuron must not generate any action potential, and following the exceeding of a regulation voltage by the membrane voltage, the steps consisting in controlling the current injector so as to modify the charge of the membrane capacitor and to modify a register of threshold exceeds. When the impulse neuron is able to generate an action potential, this register is queried to decide whether or not to generate such an action potential on an output of the neuromorphic circuit.

What is claimed is:

1. Neuromorphic circuit of the impulse neuron type, comprising a capacitor (Cₘₑₘ) at the terminals of which is established a membrane voltage (Vₘₑₘ), an action comparator (1) configured to compare the membrane voltage to a first action voltage (V_{act}) and a device for reinitialising the membrane voltage (3), wherein it further comprises a first regulation comparator (4) for comparing the membrane voltage with a first regulation voltage (V_{reg}), a register of threshold exceeds (5) and a regulator (2) configured:
in case of exceeding the first regulation voltage (V_{reg}) by the membrane voltage, to control the device for reinitialising the membrane voltage (3) and modify the register of threshold exceeds (5); and
in case of exceeding the first action voltage (V_{act}) by the membrane voltage, to control the device for reinitialising the membrane voltage (3) and query the register of threshold exceeds to decide whether or not to generate an action potential (Sₚₐ) on an output of the neuromorphic circuit.

2. The neuromorphic circuit of claim 1, wherein the regulator (2) is configured to, in case of exceeding the first action voltage (V_{act}) by the membrane voltage, control the device for reinitialising the membrane voltage so as to modify the charge of the membrane capacitor by a predetermined charge quantity.

3. The neuromorphic circuit according to claim 1, wherein the regulator is configured to, in case of exceeding the first regulation voltage (V_{reg}) by the membrane voltage, control the device for reinitialising the membrane voltage so as to modify the charge of the membrane capacitor by a predetermined charge quantity.

4. The neuromorphic circuit according to claim 1, wherein the register of threshold exceeds (5) is a counter that is decremented in case of exceeding the first regulation voltage (V_{reg}) by the membrane voltage and which, when it indicates a negative value, is incremented in case of exceeding the first action voltage (V_{act}) by the membrane voltage.

5. The neuromorphic circuit according to claim 4, wherein in case of exceeding the first action voltage (V_{act}) by the membrane voltage, the regulator decides to generate an action potential when the counter indicates a zero value, with the latter then not being modified.

6. The neuromorphic circuit according to claim 1, comprising a second regulation comparator configured to compare the membrane voltage to a second regulation voltage (V_{threshold_high}) and a second action comparator configured to compare the membrane voltage to a second action voltage, and wherein the regulator is further configured:
in case of exceeding the second regulation voltage by the membrane voltage, to control the device for reinitialising the membrane voltage (3) and modify the register of threshold exceeds (5);
in case of exceeding the second action voltage by the membrane voltage to control the device for reinitialising the membrane voltage (3) and query the register of exceed registers to decide whether or not to generate an action potential (Sₚₐ) on an output of the neuromorphic circuit.

7. The neuromorphic circuit according to claim 6, wherein the regulator is configured to control the device for reinitialising the membrane voltage and modify the register of threshold exceeds in case of exceeding the first or the second regulation voltage by the membrane voltage only during a time window following the emission of an action potential on an output of the neuromorphic circuit, the action potential being of a first or of a second type.

8. The neuromorphic circuit according to claim 7, wherein the regulator is furthermore configured to decide whether or not to generate an action potential of the first type or of the second type (Spike_{POS}, Spike_{NEG}) on an output of the neuromorphic circuit at the expiry of said time window.

9. The neuromorphic circuit according to claim 7, wherein the register of threshold exceeds is a counter and the regulator is configured, during said time window, to increment the counter in case of exceeding the second regulation voltage by the membrane voltage and to decrement the counter in case of exceeding the first regulation voltage by the membrane voltage.

10. The neuromorphic circuit according to claim 7, wherein the regulator is furthermore configured, at the expiry of said time window, to generate an action potential of the first type (Spike_{POS}) and to decrement the counter if the counter indicates a positive value and to generate an action potential of the second type (Spike_{NEG}) and to increment the counter if the counter indicates a negative value.

11. The neuromorphic circuit according to claim 7, wherein the regulator is furthermore configured to generate an action potential of the first type (Spike_{POS}), respectively of the second type (Spike_{NEG}), on the output of the neuromorphic circuit in case of exceeding, outside the time window, the first action voltage, respectively the second action voltage, by the membrane voltage.

12. The neuromorphic circuit according to claim 6, exploiting a same high threshold comparator to constitute the first action comparator and the second regulation comparator and a same low threshold comparator to constitute the second action comparator and the first regulation comparator.

13. Network of artificial neurons, comprising a plurality of neuromorphic circuits according to claim 1.

14. Method for controlling a neuromorphic circuit of the impulse neuron type which comprises a capacitor (Cₘₑₘ) at the terminals of which is established a membrane voltage (Vₘₑₘ) and a device for reinitialising the membrane voltage (3), wherein it comprises the steps consisting:
following the exceeding of a regulation voltage (V_{reg}) by the membrane voltage, in controlling the device for reinitialising the membrane voltage and in modifying a register of threshold exceeds;
in case of exceeding of an action voltage (V_{act}) by the membrane voltage, in controlling the device for reinitialising the membrane voltage (3) and in querying the register of threshold exceeds to decide whether or not to generate an action potential (Sₚₐ) on an output of the neuromorphic circuit.
